(19) United States
(12) Patent Application Publication
(10) Pub. No.: US 2018/0211404 A1
(43) Pub. Date: Jul. 26, 2018

(54) 3D MARKER MODEL CONSTRUCTION AND REAL-TIME TRACKING USING MONOCULAR CAMERA

(71) Applicant: Hong Kong Applied Science and Technology Research Institute Co., Ltd., Shatin (HK)

(72) Inventors: Xinghua Zhu, Shenzhen (CN); Jingjie Li, Shatin (HK); Felix Chow, New Territories (HK)

(21) Appl. No.: 15/412,948

(22) Filed: Jan. 23, 2017

(51) Int. Cl. G06T 7/70; G06T 17/10

(52) U.S. Cl. CPC G06T 7/70; G06T 19/006; G06T 17/10

(57) ABSTRACT

Systems, methods, and computer-readable storage media for constructing and using a model for tracking an object are disclosed. The model may be constructed from a plurality of images and a coordinate system defined with respect to the pedestal upon which the object is placed, where the plurality of images correspond to images of the object while the object is placed on a pedestal, and where the pedestal includes a plurality of markers. The model for tracking the object may be configured to provide information representative of a camera position during tracking of the object using a camera. Tracking the object using the model may include obtaining one or more images of the object using a camera, and determining a position of the camera relative to the object based on the model.

### TECHNICAL FIELD

The present application generally relates to electronic object recognition, and more particularly to improved techniques for constructing models of three dimensional objects and tracking three dimensional objects based on the models.

### BACKGROUND

Augmented reality (AR) is a live direct or indirect view of a physical, real-world environment whose elements are augmented by computer-generated sensory input such as sound, video, graphics, and the like using a variety of techniques. One problem that arises in connection with AR functionality is that it may be difficult to orient the camera such that augmented content, such as overlaid graphics, properly align with a scene within the field of view of a camera. Marker-based AR techniques have been developed in an attempt to overcome this problem. In marker-based AR, an application is configured to recognize markers present in a real-world environment, which helps orient and align a camera. Markers may be two dimensional, such as a barcode or other graphic, or may be three dimensional, such as a physical object.

Regardless of whether the marker-based AR application utilizes two dimensional markers, three dimensional markers, or both, the application must be programmed to recognize the markers. Typically, this is accomplished by providing the application with a model of the marker. Generation of models for two dimensional markers is simpler than three dimensional markers. For example, three dimensional markers often require use of specialized software (e.g., three dimensional modelling software) or three dimensional scanners to generate three dimensional models of the object. The process of generating three dimensional models for use in marker-based AR systems is a time consuming process and requires significant amounts of resources (e.g., time, cost, computing, etc.) if a large library of markers are to be used.

### BRIEF SUMMARY

The present disclosure describes systems, methods, and computer-readable storage media for constructing and using a model for tracking a three dimensional object. In embodiments, a model of a three dimensional object may be constructed using a plurality of two dimensional images. The images of the three dimensional object used to construct the model may be captured by a monocular camera from a plurality of positions. The three dimensional object may be resting on a pedestal as the images are captured by the camera, and a coordinate system may be defined with respect to the pedestal. The pedestal may include a plurality of markers, and the coordinate system may be defined based at least in part on the plurality of markers. The coordinate system may allow the model be used to determine a position of the camera relative to the three dimensional object based on a captured image. In embodiments, the model may comprise information associated with one or more features of the three dimensional object, such as information associated with features points identified from images containing the three dimensional object. For a particular image, the features of the three dimensional object may be identified through image processing techniques.

In addition to identifying features or feature points of the object, the image processing techniques may analyze the images to identify any markers of the pedestal that are present within the image(s). The markers may be used to provide camera position information that indicates the position of the camera when the image was captured. The camera position information may be stored in association with the corresponding features. In this manner, the position of a camera may be determined by first matching features or feature points identified in an image of the three dimensional object to features or feature points of the model, and then mapping the features points to the corresponding camera position determined during construction of the model. This may enable the model to provide information descriptive of a camera position relative to the three dimensional object based on an image of the three dimensional object when it is not resting on the pedestal.

In embodiments, the model may be configured to enable tracking of the three dimensional object using a monocular camera. The coordinate system may enable the model to provide information associated with the camera position relative to the three dimensional object during tracking. During tracking operations, an image or stream of images may be received from a camera. The image or stream of images may be analyzed to identify features present in the image(s). The features may then be compared to the features of the model to determine whether the three dimensional object corresponding to the model is present in the image(s). If the three dimensional object is determined to be present in the image(s), the position of the camera relative to the object may be determined based on the model (e.g., by matching the features determined from the image to features included in the model an then mapping the features to a camera position based on the model). In embodiments, the position of the camera relative to the three dimensional object may allow an AR application to direct a user regarding how to position the camera into a target camera position, such as a position suitable for performing AR operations (e.g., overlaying one or more graphics on the image in a proper alignment with respect to a scene depicted in the image).

The foregoing has outlined rather broadly the features and technical advantages of the present invention in order that the detailed description that follows may be better understood. Additional features and advantages will be described hereinafter which form the subject of the claims. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of embodiments described herein, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present embodiments.

### BRIEF DESCRIPTION OF THE DRAWINGS

For a more complete understanding, reference is now made to the following descriptions taken in conjunction with the accompanying drawings, in which:

FIG. 1 is a block diagram illustrating aspects of a pedestal configured for use in generating a model of a three dimensional object in accordance with embodiments;

FIG. 2 is a block diagram illustrating additional aspects of a pedestal configured for use in generating a model of a three dimensional object in accordance with embodiments;

FIG. 3 is a block diagram illustrating a three-dimensional object that has been prepared for imaging in connection with generating a model of the three dimensional object in accordance with embodiments;

FIG. 4 is a block diagram illustrating a coordinate system defined with respect to a pedestal in accordance with embodiments;

FIG. 5 is a block diagram illustrating a process for capturing images of a three dimensional object to construct a model of the three dimensional object in accordance with embodiments;

FIG. 6 is block diagram illustrating additional aspects a process for capturing images of a three dimensional object to construct a model of the three dimensional object in accordance with embodiments;

FIG. 7 is a diagram illustrating aspects of an application configured to utilize marker-based AR;

FIG. 8 is a block diagram illustrating a system for generating models of three dimensional objects and for tracking three dimensional objects using the models in accordance with embodiments;

FIG. 9 is a diagram depicting various views of features of a three dimensional object;

FIG. 10A is a block diagram illustrating a plurality of three dimensional objects;

FIG. 10B is a block diagram illustrating additional aspects of exemplary AR functionality for tracking a three dimensional object using models constructed according to embodiments;

FIG. 10C is a block diagram illustrating additional aspects of exemplary AR functionality for tracking a three dimensional object using models constructed according to embodiments;

FIG. 10D is a block diagram illustrating additional aspects of exemplary AR functionality for tracking a three dimensional object using models constructed according to embodiments;

FIG. 10E is a block diagram illustrating additional aspects of exemplary AR functionality for tracking a three dimensional object using models constructed according to embodiments;

FIG. 11 is a flow diagram of a method for generating a model of a three dimensional object in accordance with embodiments; and

FIG. 12 is a flow diagram of a method for tacking a three dimensional object using a model constructed in accordance with embodiments.

### DETAILED DESCRIPTION

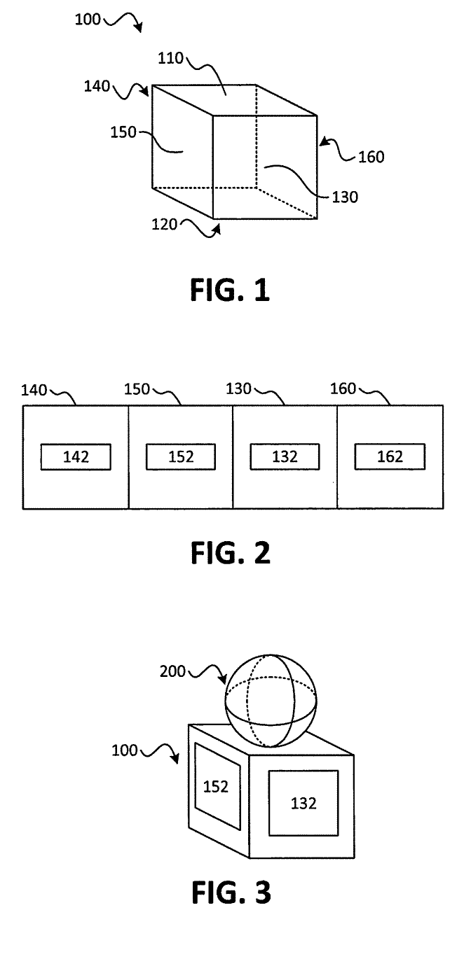

Referring to FIG. 1, a block diagram illustrating aspects of a pedestal configured for use in generating a model of a three dimensional object in accordance with embodiments is shown. Pedestal 100 of FIG. 1 includes a top surface 110, a bottom surface 120, and sides 130, 140, 150, 160. According to embodiments, during model construction, a plurality of images of the three dimensional object may be captured while the three dimensional object is placed on top surface 110 of pedestal 100, as described in more detail below with reference to FIGS. 3, 5, 6, and 8. In embodiments, the plurality of images may be two dimensional images captured using a monocular camera.

In embodiments, a plurality of markers may be present on the pedestal. For example, and referring to FIG. 2, a block diagram illustrating additional aspects of a pedestal configured for use in generating a model of a three dimensional object in accordance with embodiments is shown. As shown in FIG. 2, the sides 130, 140, 150, 160 of the pedestal 100 may comprise markers. For example, side 130 comprises marker 132, side 140 comprises marker 142, side 150 comprises marker 152, and side 160 comprises marker 162. The markers 132, 142, 152, 162 may be configured to be detected by an application configured to generate a model based on images of a three dimensional object placed on top of pedestal 100. Detection of the markers 132, 142, 152, 162 may enable the application to determine information associated with the three dimensional object relative to a coordinate system, as described in more detail below.

In embodiments, the markers 132, 142, 152, 162 may comprise two dimensional markers. For example, the markers 132, 142, 152, 162 may comprise barcodes, sequences of alphanumeric characters, dots, colors, patterns of colors, or other marks that may be recognized through image analysis. In embodiments, each of the markers 132, 142, 152, 162 may uniquely correspond to, and identify, a particular one of the sides of the pedestal 100. It is noted that in some embodiments, one or more markers may be placed on top surface 110 of the pedestal 100. The one or more markers placed on the top surface of the pedestal 100, when detectable in the image(s) of the three dimensional object may indicate that the object is being imaged from a higher angle relative to the pedestal 100 than when the detectable images are not present in the image(s). For example, if all of the markers present on the top of the pedestal are detected in an image of the three dimensional object, this may indicate that the image was captured in an orientation where the camera was looking down on the object (e.g., from substantially directly above the pedestal). As another example, when one or more of the markers placed on the top surface 110 of the pedestal 100 and one or more of the markers 132, 142, 152, 162 are detected in an image of the three dimensional object, this may indicate that the image was captured in an orientation where the camera was looking down on the object (e.g., from above the pedestal 100 at an angle), but not looking directly down on the three dimensional object and the top surface 110 of the pedestal 100. When the one or more markers are placed on the top of the pedestal 100, they may be arranged such that they are at least partially unobstructed by the object.

Referring to FIG. 3, a block diagram illustrating a three-dimensional object that has been prepared for imaging in connection with generating a model of the three dimensional object in accordance with embodiments is shown. In FIG. 3, the pedestal 100 of FIG. 1 is shown with a three dimensional object 200 (depicted in FIG. 3 as a spherical object, such as a ball) placed on the top surface 110 of the pedestal 100. As described in more detail below, in embodiments, models of the three dimensional object 200 may be constructed using images captured while the three dimensional object is situated on the top surface 110 of the pedestal 100. It is noted that the images of the three dimensional object may be captured such that the pedestal 100 is visible within the images. This may enable construction of a model of the three dimensional object that is configured to provide camera position information corresponding to a position of the camera relative to the three dimensional object (e.g., during operations to provide AR functionality) when the image was captured.

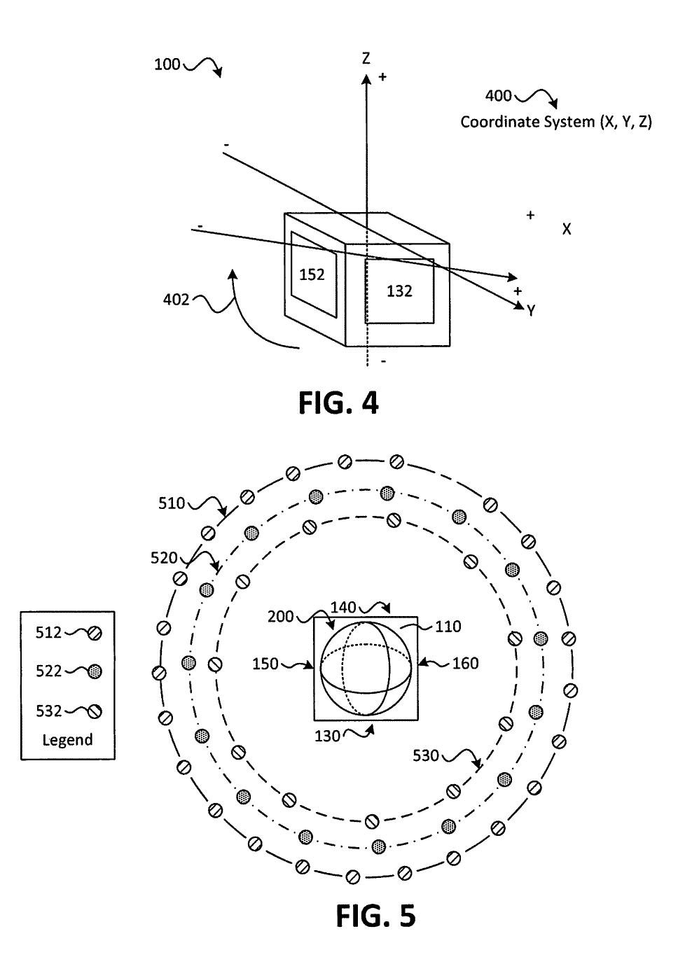

To provide the position information, a coordinate system may be defined relative to the pedestal 100. For example, and referring to FIG. 4, a block diagram illustrating a coordinate system defined with respect to a pedestal in accordance with embodiments is shown. As shown in FIG. 4, a coordinate system 400 may be defined relative to the pedestal 100 of FIG. 1. In an embodiment, an origin (e.g., coordinates “0,0,0”) of the coordinate system 400 may be configured at the center of the top surface 110 of the pedestal 100, as shown in FIG. 4. In additional or alternative embodiments, the origin of the coordinate system 400 may be configured at a different location of the top surface 110 of the pedestal 100. As illustrated in FIG. 4, the surface 130 comprising the marker 132 may be facing in a positive direction along the Y-axis of the coordinate system 400, the surface 140 comprising the marker 142 may be facing in a negative direction along the Y-axis, the surface 150 comprising the marker 152 may be facing in a negative direction along the X-axis of the coordinate system 400, the surface 160 comprising the marker 162 may be facing in a positive direction along the X-axis, the top surface 110 may be facing in a positive direction along the Z-axis of the coordinate system 400, and the bottom surface 120 may be facing in a negative direction along the Z-axis.

The coordinate system may enable the model to provide directional information for orienting a camera into a target orientation (e.g., an orientation in which a graphical overlay or other AR functionality is properly aligned with the environment depicted in the image of the object). For example, assume that a front portion of the three dimensional object faces in the direction of the positive Y-axis. Now assume that the target orientation of the camera indicates that the image of the environment or three dimensional object should be captured from the left side of the three dimensional object (e.g., the side of the object along the negative X-axis). If an image of the three dimensional object received from a camera is analyzed and it is determined that the camera is oriented towards the front of the three dimensional object (e.g., the camera is oriented along the Y-axis and is viewing the object in the direction of the negative Y-axis), the model may be used to determine that, in order to properly orient the camera to view the three dimensional object from the left side, the camera needs to be moved in a negative direction along both the X-axis and the Y-axis while maintaining the camera pointed towards the three dimensional object. It is noted that in embodiments, feature matching techniques may be implemented by the AR application to identify the three dimensional object, such as to identify which model corresponds to the three dimensional object, and to track the three dimensional object as the camera is moved, as described in more detail below.

Referring to FIG. 5, a block diagram illustrating a process for capturing images of a three dimensional object to construct a model of the three dimensional object in accordance with embodiments is shown. In FIG. 5, the pedestal 100 of FIG. 1 is shown (e.g., looking down directly on top of the top surface 110 of pedestal 100) and the three dimensional object 200 of FIG. 3 is shown resting on the top surface 110. To construct the model of the three dimensional object 200, a plurality of images may be captured of the three dimensional object 200 while placed on the pedestal 100. The captured images may include or depict both the three dimensional object 200 and the pedestal 100 (e.g., in order to capture or identify the markers present on the pedestal 100).

In embodiments, the plurality of captured images may be captured at different points surrounding the three dimensional object 200. For example, in FIG. 5, the plurality of images may include images captured at a first set of locations or points 512 along a first path 510, a second set of locations or points 522 along a second path 520, and a third set of locations or points 532 along a third path 530. It is noted that although the first path 510, the second path 520, and the third path 530 are depicted in FIG. 5 as circles, the points or locations at which the images of the three dimensional object are captured need not be circular. Instead, embodiments utilize images captured at a plurality of points surrounding the three dimensional object so that the plurality of images may provide sufficient information for constructing the model (e.g., the plurality of images capture enough identifiable features of the three dimensional object to enable the three dimensional object to be defined by a model comprising information descriptive of the identifiable features).

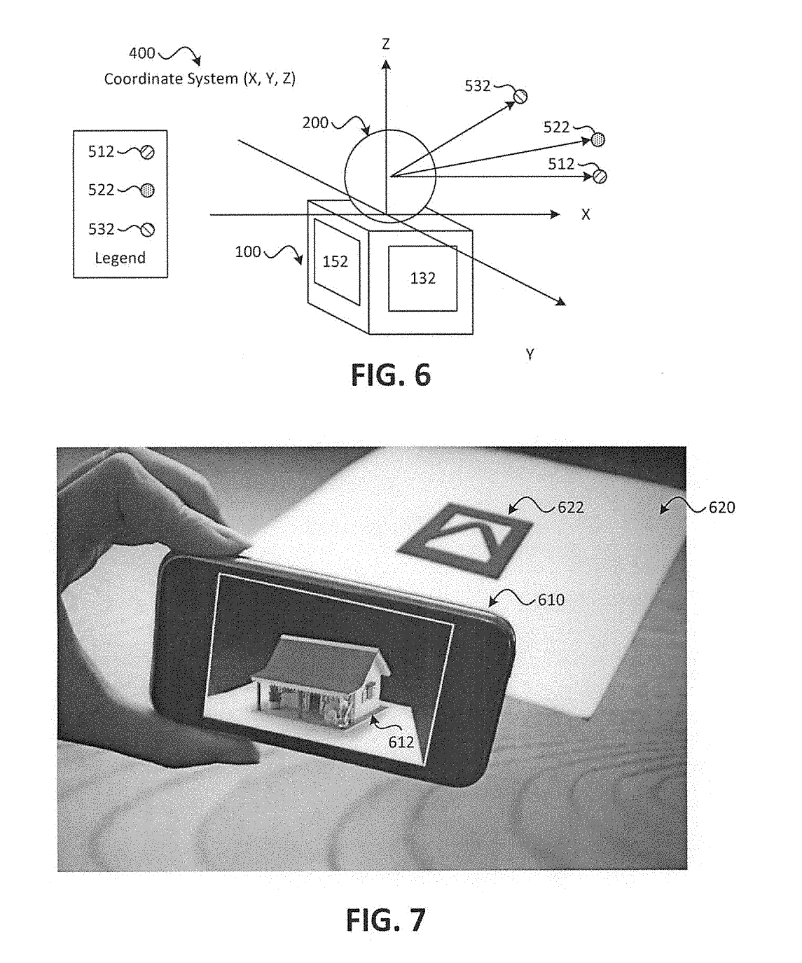

In embodiments, each of the plurality of images may be captured at substantially the same angle. In embodiments, the plurality of images of the three dimensional object 200 may be captured at a plurality of angles. For example, and referring to FIG. 6, a block diagram illustrating additional aspects of a process for capturing images of a three dimensional object to construct a model of the three dimensional object in accordance with embodiments is shown. In FIG. 6, the pedestal 100 is shown with the three dimensional object 200 resting on the top surface 110 of the pedestal 100. Additionally, the coordinate system 400 of FIG. 4 is shown. As illustrated in FIG. 6, when the camera is orientated at the first set of locations or points 512 along the path 510, the camera may capture images of the three dimensional object 200 while viewing the three dimensional object 200 at an angle that is substantially perpendicular to a midpoint of the height of the three dimensional object 200 and that is parallel to the top surface 110 of the pedestal 100. When the camera is orientated at the second set of locations or points 522 along the path 520, the camera may capture images of the three dimensional object 200 while viewing the three dimensional object 200 at an angle that is slightly higher than the midpoint of the height of the three dimensional object 200, and when the camera is orientated at the third set of locations or points 532 along the path 530, the camera may capture images of the three dimensional object 200 while viewing the three dimensional object 200 at an angle that is greater than the angle associated with the second set of locations or points 522.

Capturing the plurality of images of the three dimensional object from different angles may improve the capabilities of the model. For example, as briefly described above, the model may be utilized during tracking of the three dimensional object 200. During tracking of the three dimensional object 200 using the model, an image or stream of images depicting the three dimensional object 200 may be analyzed to identify features of the three dimensional object 200 from within the image or stream of images. The model may be utilized to identify information, within the model, corresponding to the identified features, and then provide information associated with an orientation of the camera based on the model, such as based on the coordinate system 400 and/or based on other information included in the model, as described in more detail below. Thus, acquiring images from different angles during construction of the model may enable the features of the three dimensional object 200 to be identified more easily (e.g., because there are more angles in which the features of the three dimensional object can be identified).

In embodiments, the plurality of images may include at least 100 images of the three dimensional object 200 while it is placed on the pedestal 100. In additional or alternative embodiments, the plurality of images may include more than 100 images or less than 100 images of the three dimensional object 200 while it is placed on the pedestal 100. The particular number of images included in the plurality of images may be based on a number of features or feature points that are identifiable for the three dimensional object, a strength of the identifiable features or feature points that are identifiable for the three dimensional object, a size of the three dimensional object, a complexity of patterns identifiable for the three dimensional object, other factors, or a combination thereof, as described in more detail below.

Referring to FIG. 7, a diagram illustrating aspects of an application configured to utilize marker-based AR is shown. In FIG. 7, a mobile communication device 610 and a piece of paper 620 resting on a table surface are shown. The paper 620 includes a marker 622. As shown in FIG. 7, the marker 622 may be identified by an application executing on the mobile device 610 by capturing an image of the paper 620 and identifying the marker 622. Once the marker 622 is identified, the application may present a graphical overlay 612 on a display of the mobile device 610, where the graphical overlay 612 appears on the screen in such a way that the graphical overlay 612 appears to be resting on top of the piece of paper 620. In a similar manner, embodiments may facilitate AR applications and functionality using three dimensional markers, such as models of three dimensional objects constructed from a plurality of images of the three dimensional model captured by a monocular camera while the three dimensional model is placed on a pedestal (e.g., the pedestal 100 of FIG. 1).

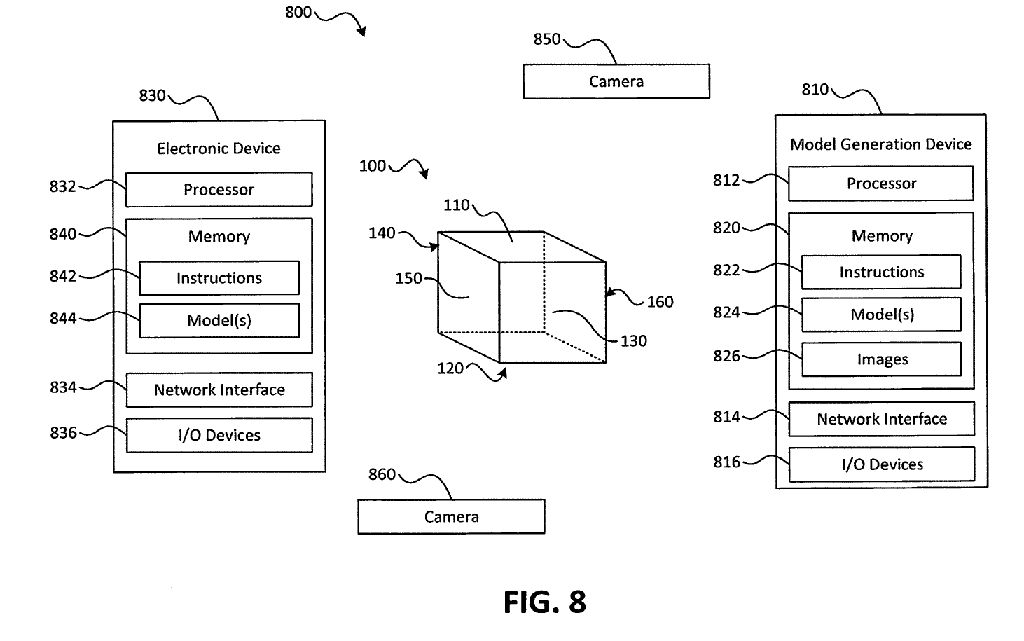

Referring to FIG. 8, a block diagram of a system for generating models of three dimensional objects and for tracking three dimensional objects using the models in accordance with embodiments is shown as a system 800. As shown in FIG. 8, the system 800 comprises the pedestal 100 of FIG. 1, a model generation device 810, and a camera 850. The model generation device 810 may be configured to construct models of three dimensional objects based on images captured by the camera 850 and a coordinate system defined with respect to the pedestal 100. The models constructed by the model generation device 810 may be configured to enable an application to track a three dimensional object, such as the three dimensional object 200, using a camera, such as a monocular camera commonly present on mobile communication devices, for example. Additionally, the models constructed by the model generation device 810 may be configured to provide position information representative of a camera position relative to the three dimensional object based on features or feature points identified in an image of the three dimensional object captured using a monocular camera.

As shown in FIG. 8, the model generation device 810 includes one or more processors 810, a memory 820, a network interface 814, and one or more input/output (I/O) devices 816. In embodiments, the network interface 814 may be configured to communicatively couple the model generation device 810 to one or more external devices, such as electronic device 830, via one or more networks. For example, the model generation device 810 may be configured to generate models of three dimensional objects in accordance with embodiments, and then distribute the models to the external devices to facilitate AR operations at the external devices. In embodiments, the one or more I/O devices 816 may include a mouse, a keyboard, a display device, the camera 850, other I/O devices, or a combination thereof.

The memory 820 may store instructions 822 that, when executed by the one or more processors 812, cause the one or more processors to perform operations for generating models of three dimensional objects in accordance with embodiments. Additionally, in embodiments, the memory 820 may store a database 824 ne or more models. Each of the models included in the database 824 may correspond to a model constructed in accordance with embodiments. For example, each of the different models may be constructed by placing a different three dimensional object on the pedestal 100, and then capturing a plurality of images of the three dimensional objects while placed on the pedestal, as described above with reference to FIGS. 1-6. In embodiments, the images of a three dimensional object captured while placed on the pedestal 100 may be stored in a database 826 of images. This may enable the images to be processed later (e.g., for model generation purposes). For example, a user may capture images during the day, and then the images may be processed overnight to generate the model(s).

During processing of the images, each of the images may be analyzed to determine camera position information and features points. The camera position information may be determined by identifying one or more of the markers 132, 142, 152, 162 of the pedestal 100 that are present within each of the images. The feature points identified in an image may be stored in correspondence with the camera position information such that identification of a set of feature points from an image of the three dimensional object while the object is not on the pedestal 100 can be matched to a set of feature points of the model and then mapped to a camera position corresponding to the matched set of feature points, thereby enabling a camera position relative to the object to be determined based on images of the three dimensional object without requiring the three dimensional object to be placed on the pedestal.

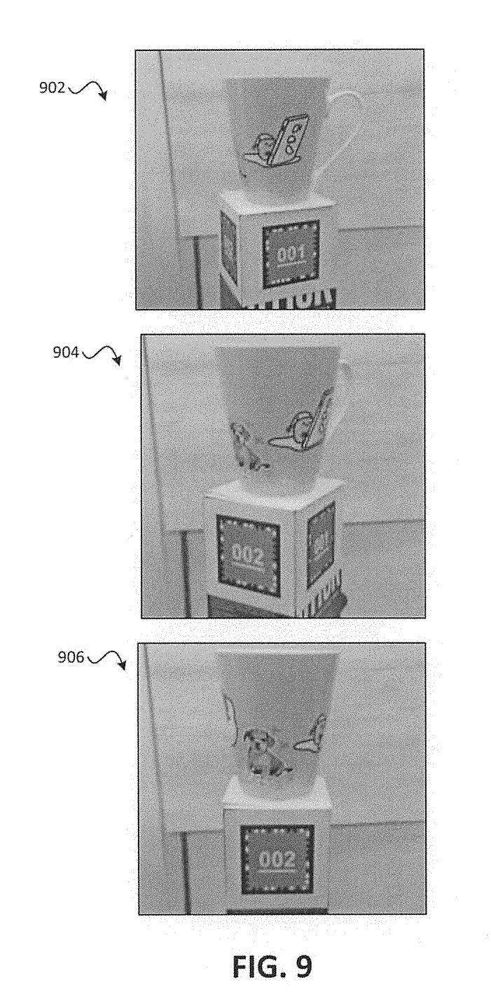

For example, and briefly referring to FIG. 9, a diagram depicting various views of a three dimensional object are shown. In FIG. 9, the three dimensional object is a cup, and the cup has been placed on a pedestal comprising markers on its various surfaces. As shown in image 902, the cup comprises a first texture comprising a graphic including a series of lines. During image analysis of the image 902, the series of lines may be translated into one or more features or feature points descriptive of the series of lines (e.g., the features or features points may comprise information that defines relationships between the lines, and other characteristics of the first texture). Image 904 illustrates the same cup on the same pedestal, but viewed or imaged by the camera from a different position. As shown in image 904, the first texture that is visible in image 902 is partially visible along the right side of the cup in image 904, and a second texture is visible along the left side of the cup in image 904. Image 906 of FIG. 9 illustrates the same cup on the same pedestal, but viewed from a different position than the images 902, 904. In the image 906, the first texture from image 902 remains partially visible along the right side of the cup, the second texture is now fully visible, and part of a third texture is visible along the left side of the cup. The images 902, 904, 906 may correspond to images that are captured during construction of a model comprising information to facilitate tracking of the cup.

Referring back to FIG. 8, as briefly described above, models constructed according to embodiments may enable an electronic device to capture an image of a three dimensional object when it is not placed on the pedestal of embodiments, and then determine the camera position relative to the three dimensional object based on the model. For example, in FIG. 8, an electronic device 830 is shown. In embodiments, the electronic device 830 may be a mobile communication device (e.g., a cell phone, a smart phone, a personal digital assistant (PDA), and the like), a tablet computing device, a laptop computing device, a wearable electronic device (e.g., a smartwatch, eyewear, and the like), or another type of electronic device that includes, or that may be communicatively coupled to a monocular camera. As shown in FIG. 8, the electronic device 830 includes one or more processors 832, a memory 840, a network interface 834, and one or more I/O devices 836. In embodiments, the network interface 814 may be configured to communicatively couple the model generation device 810 to one or more external devices, such as electronic device 830, via one or more networks. For example, the model generation device 810 may be configured to generate models of three dimensional objects in accordance with embodiments, and then distribute the models to the external devices to facilitate AR operations at the external devices via a network (not shown in FIG. 8). In embodiments, the one or more I/O devices 816 may include a mouse, a keyboard, a display device, the camera 860, other I/O devices, or a combination thereof.

As described above, a model of a three dimensional object may be constructed. The electronic device 830 may comprise an application, which may be stored at the memory 840 as instructions 842 that, when executed by the one or more processors 832, cause the one or more processors 832 to perform operations for tracking a three dimensional object using models constructed by the model generation device 830 according to embodiments. Additionally, the operations may further include determining a position of the camera 860 relative to the three dimensional object based on the models constructed by the model generation device 830 according to embodiments and based on one or more images captured by the camera 860 while the three dimensional object is not placed on the camera.

For example, and referring back to FIG. 9, suppose that the electronic device 830 is used to capture images of a cup similar to the cup illustrated in FIG. 9, except that the cup imaged by the electronic device is not resting on a pedestal. The images of the cup captured by the electronic device 830 may be analyzed to identify features of the cup, such as the textures described above. The identified features may then be transformed into feature points and the model may be used to determine the position of the camera relative to the object by comparing the feature points identified from the images to feature points defined within the model. For example, if the feature points determined by the electronic device correspond to the feature points identified for image 902 during construction of the model, it may be determined, based on the model, that the camera is positioned in a manner similar to the camera position shown at image 902 of FIG. 9. If, however, the features points determined by the electronic device correspond to the feature points identified for image 904 (e.g., feature points corresponding to the second texture and to the first texture are present, but not the third texture) during construction of the model, it may be determined, based on the model, that the camera is positioned in a manner similar to the view shown at image 904 of FIG. 9, and so on.

As shown above, the system 800 provides for generation of models of three dimensional objects based on a plurality of images of the three dimensional object captured using a monocular camera. Thus, the system 800 of embodiments enables models to be constructed for three dimensional markers or objects without the need to utilize specialized three dimensional modelling software or a three dimensional scanner. Additionally, the models constructed by the system 800 enable tracking of a three dimensional object and are configured to provide camera position information when the three dimensional object is not placed on the pedestal, which may be particularly useful for many AR applications.

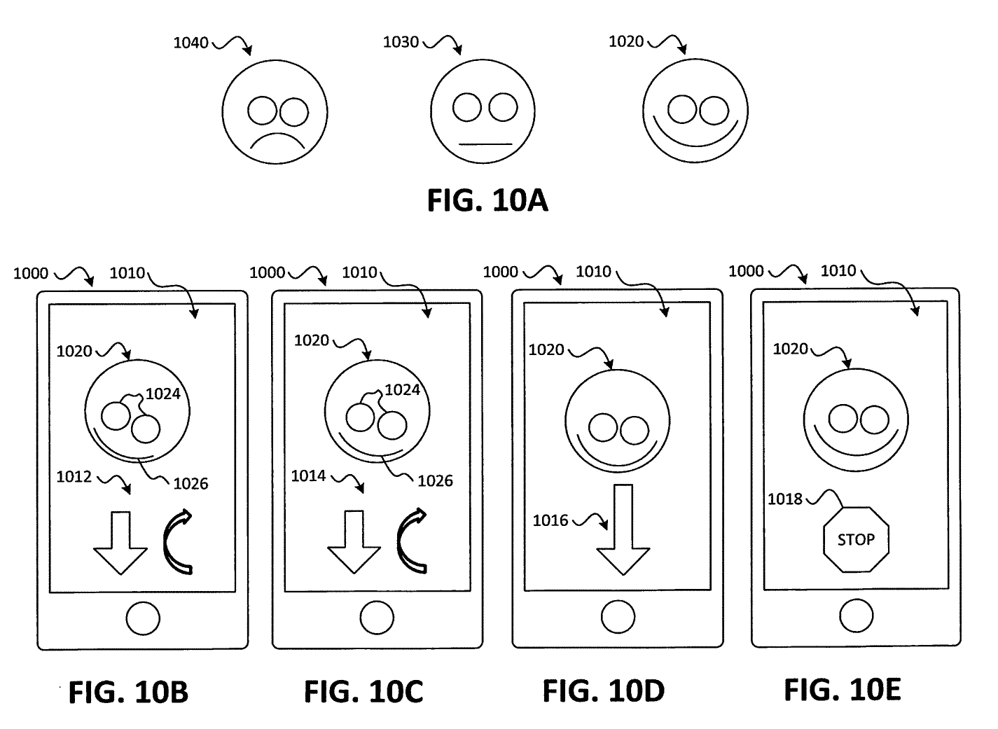

Referring to FIG. 10A, a block diagram illustrating a plurality of three dimensional objects is shown. As shown in FIG. 10A, the plurality of three dimensional objects may include a first three dimensional object 1020, a second three dimensional object 1030, and a third three dimensional object 1040. In embodiments, models of each of the three dimensional objects 1020, 1030, 1040 may be constructed according to embodiments. These models may be used to facilitate AR functionality. For example, FIGS. 10A-10E illustrate aspects of embodiments for utilizing a model constructed according to embodiments to track a three dimensional object and determine whether a camera is properly oriented with respect to the three dimensional object for purposes of performing one or more AR operations. In FIGS. 10B-10E, an electronic device 1000 having a display 1010 is shown. In embodiments, the electronic device 1000 may be a mobile communication device (e.g., a cell phone, a smart phone, a personal digital assistant (PDA), and the like), a tablet computing device, a laptop computing device, a wearable electronic device (e.g., a smartwatch, eyewear, and the like), or another type of electronic device that includes, or that may be communicatively coupled to a monocular camera.

As shown in FIG. 10B, the camera of the electronic device 1000 may capture an image (shown within display 1010) of the first three dimensional object 1020. The image may be used to track the first three dimensional object 1020 by an AR application configured to utilize models constructed according to embodiments. For example, the AR application may analyze the image and determine that the first three dimensional object 1020 is present in the image by identifying features 1024 and 1026 of the first three dimensional object 1020. In an embodiment, the AR application may recognize that the features 1024 correspond to the first three dimensional object 1020 by comparing the features to the models corresponding to each of the three dimensional object 1020, 1030, 1040. Upon matching features 1024, 1026 identified in the image captured by the camera with the first three dimensional object 1020 using the model, the AR application may determine whether the camera is oriented in a target position for performing an AR operation, such as providing a graphical overlay on top of the image.

In FIGS. 10A-10E, the target position for performing the AR operation with respect to the first three dimensional object may correspond to the orientation of the first three dimensional object 1020 as shown in FIGS. 10A and 10E. As can be seen in FIGS. 10B-10D, the camera is not in the target position for performing the AR operations. When the camera is not in the target position, the application may use the model to determined one or more directions to move the camera in order to position the camera in the target position. For example, as shown in FIG. 10B, the application may provide an output 1012 that indicates one or more directions to move the camera to position the camera in the target position (e.g., move the camera down and rotate the camera to the right or clockwise). After providing the output 1012 illustrated in the FIG. 10B, the camera may provide another image for analysis and tracking of the first three dimensional object 1020, such as the image illustrated in the display 1010 of FIG. 10C. The application may determine, based on the another image, that the first three dimensional object 1020 is in the field of view of the camera, and may use the model to again determine whether the camera is in the target position. As shown in FIG. 10C, the camera is still not in the target position/orientation, so an additional output 1014 may be generated, where the additional output 1014 is configured to indicate one or more directions to move the camera to position the camera in the target position (e.g., move the camera down and rotate the camera to the right or clockwise). In. FIG. 10D, the image provided by the camera may be analyzed and it may be determined that the camera needs to be moved down in order to place the camera in the target position, as indicated by output 1016. The user of the electronic device 1000 may follow the direction indicated by output 1016 and when the camera is the target position, shown in FIG. 10E, the electronic device 1000 may provide an output 1018 indicating that the camera is placed in the target position. Once in the target position, the application may determine whether to perform one or more AR operations, or whether to prompt the user for instructions to perform the one or more AR operations, such as displaying a graphical overlay that covers at least a portion of the first three dimensional object 1020. By positioning the camera in the target position, the graphical overlay may be placed or overlaid within the image in proper alignment with the scene depicted by the image.

In embodiments, the directions and rotations indicated by the outputs 1012, 1014, 1016 may be determined using the local coordinate system of the model. For example, the features 1024 and 1026, when first identified in the image of FIG. 10A, may be compared to the model and matched to features defined within the model. Once the features are identified within the model, the position of the camera relative to the three dimensional object may be estimated based on the position of the camera during construction of the model. For example, as described above, the model comprises position information that correlates or maps position information and feature information. In embodiments, the outputs 1012, 1014, 1016, 1018 may be generated based at least in part on the model. For example, through analysis of the images, the application may identify one or more feature points, and then may use the coordinate system of the model to determine the outputs 1012, 1014, 1016, 1018.

As shown above, models constructed according to embodiments may enable tracking of a three dimensional object based on images captured using a monocular camera. Additionally, models constructed according to embodiments enable camera position information to be determined relative to a three dimensional object based on feature points identified within an image, which may simplify implementation of various AR functionality.

Further, models constructed according to embodiments may be smaller in size than those constructed with three dimensional scanners and/or three dimensional modelling software. Typically, a three dimensional model comprises a very dense point cloud that contains hundreds of thousand points. This is because in a three dimensional model constructed using a three dimensional scanner and/or three dimensional modelling software, the three dimensional object is treated as if it is made of countless points on its body (e.g., the three dimensional model utilizes every part of the surface of the object). In contrast, models constructed according to embodiments are only interested in certain points on the object's body, namely, feature points (e.g., information comprising distinguishing features or aspects of the object's body). For example, in referring back to FIG. 9, the cup depicted in the images 902, 904, 906 includes stickers comprising various graphics or images, which were placed on the cup so that the surface of the cup had distinct and/or identifiable features. This was done because generally a cup or a glass itself has a smooth body that makes it difficult to identify any specific or distinct features of the cup using image analysis techniques. The model of the cup depicted in FIG. 9 may comprise information associated with those identified features and/or feature points (e.g., edge features of the object, features or feature points corresponding to the graphics depicted in the stickers applied to the cup, etc.), but may not comprise information associated with the smooth and texture-less parts of the cup which do not provide useful information.

By including only information associated with distinct features of the three dimensional object, and excluding information that does not facilitate identification of the three dimensional object, such as information associated with smooth and texture-less portions of the object's body, models constructed according to embodiments contain less points than three dimensional models generated using three dimensional scanners and/or three dimensional modelling software, and result in models that are smaller size. This allows the models constructed according to embodiments to be stored using a smaller amount of memory than would otherwise be required (e.g., using traditional models constructed using three dimensional scanners and/or three dimensional modelling software), which may enable a device to store a larger library of three dimensional object models while utilizing less memory capacity. This may also facilitate identification of a larger number of three dimensional objects by an AR application configured to use the library of models. Additionally, by only including information in the model associated with distinct and/or identifiable features, a model constructed according to embodiments may facilitate faster identification and tracking of the three dimensional object in a real-time environment. For example, when matching a live camera-fed image with a template image or information stored in a model constructed according to embodiments, the matching process will be faster because it compares much fewer points than three dimensional models constructed using a three dimensional scanner and/or three dimensional modelling software. Further, it is noted that accuracy of the tracking and/or three dimensional object identification is not compromised because the information stored in the model comprises the most distinct features of the three dimensional object.

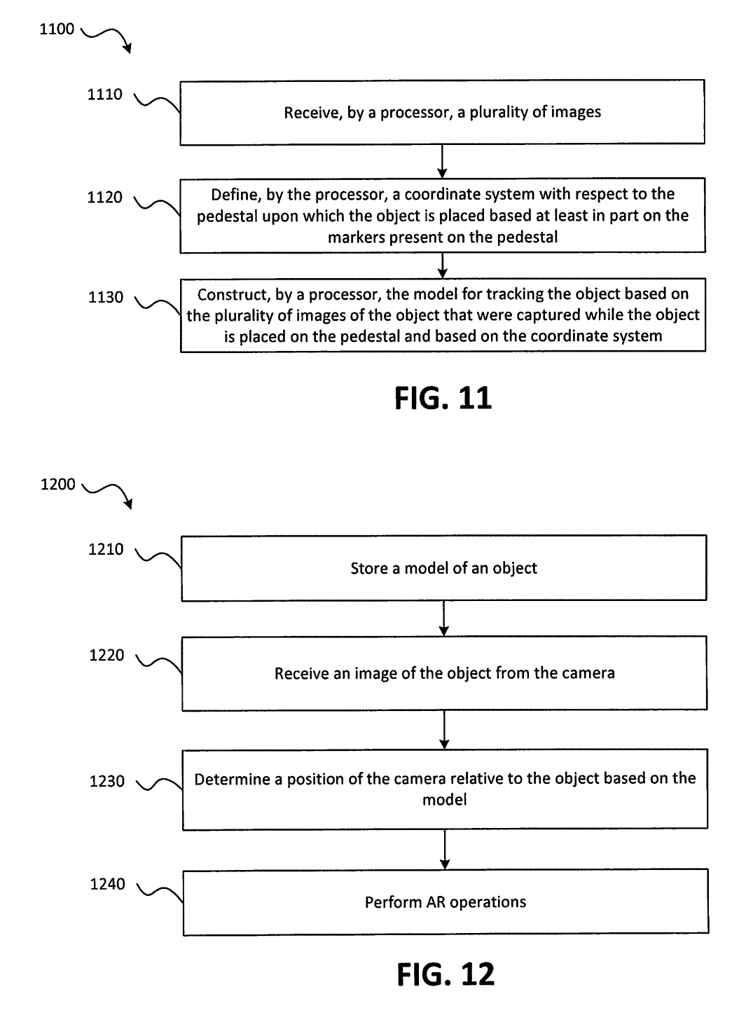

Referring to FIG. 11, a flow diagram of a method for generating a model of a three dimensional object in accordance with embodiments is shown as a method 1100. In embodiments, the method 1100 may be performed by an electronic device, such as the model generation device 810 of FIG. 8. For example, operations of the method 1100 may facilitated by an application. The application may be stored as instructions (e.g., the instructions 822 of FIG. 8) that, when executed by a processor (e.g., the processor 812 of FIG. 8), cause the processor to perform the operations of the method 1100 to construct a model of a three dimensional object in accordance with embodiments. In embodiments, the application may be programmed using one or more programming languages (e.g., C++, Java, Pearl, other types of programming languages, or a combination thereof).

At 1110, the method 1100 includes receiving, by the processor, a plurality of images. The plurality of images may correspond to images of a three dimensional object (e.g., the three dimensional object 200) while the three dimensional object is placed on a pedestal (e.g., the pedestal 100), as described above with reference to FIGS. 1-6. The plurality of images may be captured using a camera (e.g., the camera 850 of FIG. 8). In embodiments, the camera used to capture the plurality of images may be a monocular camera. The plurality of images may be received from the camera via a wired connection (e.g., a universal serial bus (USB) connection, another type of wired connection, or a combination of wired connection types) or a wireless connection (e.g., via a wireless communication network, such as a wireless fidelity (Wi-Fi) network, a Bluetooth communication link, another type of wireless connection, or a combination of wireless connection types). In an embodiment, the plurality of images may be stored in a database, such as the images database 826 of FIG. 8.

The method 1100 also includes, at 1120, defining, by the processor, a coordinate system with respect to the pedestal upon which the three dimensional object is placed. In embodiments, the coordinate system (e.g., the coordinate system 400 of FIG. 4) may be defined, based at least in part on, one or more markers present on the pedestal, such as the markers 132, 142, 152, 162 described above with reference to FIGS. 2 and 4. For example, when defining the coordinate system with respect to the pedestal upon which the object is placed further comprises, the method 1100 may assign a point of origin for the coordinate system. In embodiments, the point of origin may be defined to be located at a center of the top surface of the pedestal. Defining the coordinate system may further include orienting the coordinate system with respect to the pedestal. For example, in embodiments, the orientation of the coordinate system with respect to the pedestal may be determined based at least in part on the plurality of markers present on the pedestal, such as assigning the markers directions within the coordinate system or associating a surface of the pedestal to a particular direction within the coordinate system (e.g., the surface 130 is facing in the direction of the positive Y-axis, as described with reference to FIG. 4).

In embodiments, identifiable portions of the pedestal may be assigned positions within the coordinate system. For example, and referring back to FIG. 4, suppose that the coordinate system 400 originates at the center of top surface of the pedestal 100, and the X-axis, Y-axis, and Z-axis are measured using 1 centimeter (cm) units. As explained above, the coordinate system 400, denoted as “C” below, serves as the coordinate system for model construction. In embodiments, the three dimensional coordinates of every marker corner relative to the coordinate system C can be determined by measuring the physical side lengths of the pedestal and the printed marker. The markers, with known three dimensional structure in the reference coordinate system, may enable the camera pose to be determined with six degrees of freedom (6DOF) from the images captured of the three dimensional object (and pedestal), as described in more detail below.

As described above, during model construction, a plurality of images may be captured while the three dimensional object is situated on the pedestal 100. During the capturing of the plurality of images, the three dimensional target object may be fixated on the pedestal 100 so that it remains static relative to the pedestal 100, and thus static relative the coordinate system 400. In each of the plurality of images, at least one of the markers (e.g., at least one of the markers 132, 142, 152, 162 of FIGS. 2-4) of the pedestal 100 should be present. The markers of the pedestal 100 may be used to identify the exact positions of the marker corners in the picture with subpixel accuracy.

The camera pose may be estimated by minimizing the reprojection error of the marker corners. For example, let x_i, p_i be the three dimensional coordinates in the coordinate system 400, denoted as a coordinate system “C” below, and subpixel positions in the picture of a marker corner, respectively. proj(x_i)=(u, v) may be given by:

$$\begin{matrix}e ( C ) = {\sum }_{i = 1}^{N} {d}_{i}^{2} = {\sum }_{i = 1}^{N} {( {p}_{i} - proj ( {x}_{i} ) )}^{2} & Equation 1 \\ [ \begin{matrix}x \\ y \\ z\end{matrix} ] = R [ \begin{matrix}X \\ Y \\ Z\end{matrix} ] + t & Equation 2 \\ {x}^{′} = x \text{/} z & Equation 3 \\ {y}^{′} = y \text{/} z & Equation 4 \\ u = {f}_{x} * {x}^{′} + {c}_{x} & Equation 5 \\ v = {f}_{y} * {y}^{′} + {c}_{y} & Equation 6\end{matrix}$$

By including the markers of the pedestal 100 in the images captured of the three dimensional object, the camera pose for each picture may be determined. From Equations 1-6 above, triangulation may be used to identify corresponding points on different images, enabling the three dimensional coordinates of the feature points on the three dimensional object's surface to be determined, which may facilitate identification of relationships between different ones of the plurality of images (e.g., identification of a particular image as being captured from a particular direction relative to one or more other images of the plurality of images).

Defining a local coordinate system with respect to the pedestal, and then capturing images of the three dimensional object while placed on the pedestal may enable spatial relationships between the camera and the three dimensional object may be determined from the model using image analysis techniques, as described above. As a further example, when a particular marker of the pedestal is present in the image of the three dimensional object, it may be determined that the object is being viewed by the camera from a particular direction within the coordinate system. Storing the camera position information in correspondence with features or features points identified in a particular image enables a camera position to be determined in relation to the three dimensional object within the coordinate system when the pedestal is not present, as described above.

At 1130, the method 1100 includes constructing, by the processor, the model for tracking the three dimensional object. In embodiments, the model may be constructed based on the plurality of images of the object that were captured while the object is placed on the pedestal and based on the coordinate system. The model for tracking the three dimensional object may be configured to provide information representative of a position of a camera (e.g., the camera 860 of FIG. 8) during tracking of the three dimensional object.

In embodiments, the model may be stored in a library of models comprising a plurality of models (e.g., the library of models 824 of FIG. 8), each of the plurality of models corresponding to a different three dimensional object. In embodiments, each of the plurality of models included in the library of models may be generated using the method 1100. In additional or alternative embodiments, the library of models may include one or more models generated according to the method 1100 and one or more models generated according to other techniques, such as one or more two dimensional models. Configuring the library of models to include a plurality of different models, including both three dimensional models generated according to embodiments and two dimensional models may enable an AR application to provide more robust AR functionality, such as recognizing both two dimensional and three dimensional markers and then performing AR operations in response to detecting the presence of one or more markers based on the library of models.

In embodiments, constructing the model, at 1130, may include analyzing each of the plurality of images to identify features of the three dimensional object within each image. The features may comprise: lines, shapes, patterns, colors, textures, edge features (e.g., boundary/edge between two regions of an image, such as between the object and the background), corner features (e.g., perform edge detection and then analyze the detected edges to find rapid changes in direction, which may indicate corners), blob features (e.g., features that are focused on regions of the three dimensional object, as opposed to corners which focus more on individual points), other types of features, or a combination thereof. For detecting each type of feature, there are many implementations. In our case, we mainly use a corner detector as it is fast, accurate and suitable for a real-time environment. But whatever feature detector is being used, the same idea can be applied to construct the model.

In embodiments, the pedestal used to capture the plurality of images may be disposed in a room or chamber having a particular color of walls or some other characteristic that simplifies identification of the features of the three dimensional object (e.g., enables the image analysis algorithm to distinguish between the three dimensional object on the pedestal and background information). In embodiments, a strength of the identifiable features of the object may be determined. Strong features may correspond to features that may be easily identified, or that may be consistently identified repeatedly using image analysis techniques. For example, lines may have a strong contrast with respect to the three dimensional object, such as the textures on the cup of FIG. 9. Weak features may correspond to features that are not easily identified, or that are not easily identified repeatedly using image analysis techniques. For example, a feature that has a low contrast with respect to its surroundings may be difficult to identify consistently using image analysis techniques (e.g., fluctuations in lighting may cause the weak features to be detected sometimes, but not every time). The features may be translated into a plurality of feature points, and the model constructed according to embodiments may include information descriptive of the plurality of feature points identified within each of the plurality images. In embodiment, the plurality of feature points identified within a particular image may be stored in association with, or correspondence with a particular camera position. This enables the model to determine the position of the camera based on feature points identified in an image of the three dimensional object when the pedestal is not present.

In embodiments, the markers on the pedestal may be analyzed to determine relationships between different ones of the plurality of images. For example, during the image analysis, markers present on the pedestal may be identified. As described above, the markers on the pedestal provide information that may provide an indication of the position of the camera. For example, and referring back to FIG. 4, if the image analysis determines that the markers 132 and 152 are present in the image, it may be determined that the camera was positioned to the left of the three dimensional object (e.g., assuming that the front of the three dimensional object is facing surface 130). As another example, if the image analysis determined that only the marker 132 is present within an image, it may be determined that the camera was positioned in front of the three dimensional object (e.g., assuming that the front of the three dimensional object is facing surface 130), as described above. The position information may be stored as part of the model and may enable the model to translate feature points to camera positions, as described above.

As explained below, during tracking of the three dimensional object, one or more additional images of the three dimensional object may be captured and analyzed to identify feature points in the one or more additional images, and the feature points identified within the one or more additional images may be compared to the model to determine corresponding feature points of the model. After the corresponding feature points of the model are identified, the model may be used to determine the position of the camera used to capture the one or more additional images. The camera position corresponding to the corresponding feature points of the model may indicate the position of the camera used to capture the one or more additional images. For example, by comparing the feature points identified in a particular one of the one or more additional images with the feature points included in the model, it may be determined that the particular image was captured from a camera position that corresponds to a camera position used to capture one of the plurality of images used to construct the model.

The method 1100 provides several advantages over existing techniques for generating models suitable for use in AR applications. For example, the method 1100 enable models of three dimensional objects to be constructed using only two dimensional images, such as images captured using a monocular camera. This eliminates the need to utilize special software, such as three dimensional modelling software, to generate the models, and may enable the models to be constructed more easily. Apart from utilizing specialized software, other three dimensional modelling techniques require images to contain depth information, which can be obtained from some kinds of specialized tools, such as three dimensional scanners, or using two monocular cameras. The former is not commonly available, and the latter requires two individual cameras working together, increasing the complexity of the modelling process. As explained above, embodiments of the present disclosure enable model construction using a single monocular camera, such as may be commonly found on a mobile phones or tablet computing devices. Thus, embodiments enable three dimensional models to be constructed without the cost of specialized tools, such as three dimensional scanners or modelling software, and without requiring coordination of multiple cameras or other devices.

Referring to FIG. 12, a flow diagram of a method for tacking a three dimensional object using a model constructed in accordance with embodiments. In embodiments, the method 1200 may be performed by an electronic device, such as the electronic device 830 of FIG. 8. For example, operations of the method 1200 may be facilitated by an application. The application may be stored as instructions (e.g., the instructions 842 of FIG. 8) that, when executed by a processor (e.g., the processor 832 of FIG. 8), cause the processor to perform the operations of the method 1200 to track a three dimensional object using a model constructed in accordance with embodiments. In embodiments, the application may be programmed using one or more programming languages (e.g., C++, Java, Pearl, other types of programming languages, or a combination thereof).

At 1210, the method 1200 includes storing a model of an object. In embodiments, the model may be constructed according to the method 1100, as described above, and may be configured to enable the application to track the three dimensional object. In embodiments, the application may be configured to utilize a library comprising a plurality of models (e.g., the library of models 844 of FIG. 8), as described above. This may enable the application to identify and/or track a plurality of different three dimensional objects and perform AR functions with respect to, or based on, the tracked three dimensional objects.

At 1220, the method 1200 includes receiving an image of the object from a camera of the electronic device. In embodiments, the image may be received as a single image. In additional or alternative embodiments, the image may be received as a part of a stream of images. For example, the camera may be operated in a video mode and the image may be received as part of a stream of images corresponding to video content captured by the camera.

At 1230, the method 1200 includes determining a position of the camera relative to the three dimensional object based on the model. For example, the camera position relative to the three dimensional object may be determined based on the model using the position information defined by the model. In embodiments, the camera position may be determined by correlating feature points of the three dimensional object identified within the image captured by the camera to feature point information defined within in the model, where the feature points defined within the model are mapped to camera position information derived during construction of the model, as described above.

At 1240, the method 1200 may include performing one or more AR operations based on the position of the camera relative to the three dimensional object. For example, in embodiments, the AR operations may include providing a graphical overlay that appears within the scene depicted by the image from which the position and/or orientation of the camera was determined. To ensure that the graphical overlay is properly aligned within the scene, the three dimensional object may be used as a three dimensional marker. The proper alignment may be achieved by placing the camera in a target camera position. In embodiments, the target camera position for the camera relative to the object may be determined based on information defined within the model and/or information associated with the particular graphical overlay to be applied (e.g., different graphical overlays may have different target camera positions with respect to the three dimensional object), as described above with respect to FIGS. 10A-10E. In addition to the aforementioned functionality and AR operations, models constructed according to embodiments may be applied in a variety of different industries and applications, including, but not limited to, the medical industry, the video game industry, the home industry (e.g., home construction, design, decoration, etc.), and the like.

In embodiments, the method 1200 may further include determining a quality metric representative of a strength of the correlation of the image of the object to one of the plurality of images of the object used to construct the model, and determining whether the quality metric satisfies a tracking threshold. The graphical overlay may be provided, based at least in part, on a determination that the quality metric satisfies the tracking threshold. For example, a determination that the quality metric does not satisfy the threshold may indicate that the object is not being tracked by the camera. In such case, the AR operation may not be performed. Utilizing the quality metric may assist with identifying the three dimensional object when a portion of the three dimensional object is not visible within the image. For example, a particular set of features points may provide a strong indication that the three dimensional object is present within an image while another set of feature points may provide a weak indication that the three dimensional object is present within the image. When the particular set of strong feature points is identified within the image, the three dimensional object may be identified as present within the image even when the another set of weak feature points are not identified in the image.

As shown above, the method 1200 may enable a camera position relative to a three dimensional object to be determined from a model constructed from a plurality of images of the three dimensional object while the object is positioned on a pedestal. Additionally, the method 1200 facilitates tracking of a three dimensional object using a model constructed from a plurality of images of the three dimensional object while the object is positioned on a pedestal. AR applications and functionality are increasingly seeking to operate in a real-time environment in which the camera (usually handheld device) is constantly moving. As described above, the methods of embodiments for tracking position and orientation of a camera and identification of a three dimensional object using models constructed according to embodiments may be relatively faster than other techniques. This is because models constructed according to embodiments are constructed with a relatively sparse points-based model of the three dimensional object with only the feature points (e.g., the identified distinct or identifying features), whereas other three dimensional models (e.g., models constructed using three dimensional scanners and/or modelling software) comprise dense models that include large point clouds that include points corresponding to non-distinct and non-distinguishing features of the three dimensional object. This enables methods for tracking of camera position/orientation and identification of three dimensional objects according to embodiments to be performed faster since there are less points in the model to compare to points identified in real-time images received from a camera.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods and steps described in the specification.

What is claimed is:

1. A method for constructing a model for tracking an object, the method comprising:
receiving, by a processor, a plurality of images, wherein the plurality of images correspond to images of the object while the object is placed on a pedestal, and wherein a plurality of markers are present on the pedestal;
defining, by the processor, a coordinate system with respect to the pedestal upon which the object is placed based at least in part on the markers present on the pedestal; and
constructing, by a processor, the model for tracking the object based on the plurality of images of the object that were captured while the object is placed on the pedestal and based on the coordinate system, wherein the model for tracking the object is configured to provide information representative of a camera position based on a subsequent image of the object when the pedestal is not present.

2. The method of claim 1, wherein defining, by the processor, the coordinate system with respect to the pedestal upon which the object is placed further comprises:
assigning, by the processor, a point of origin for the coordinate system; and
orienting, by the processor, the coordinate system based at least in part on the plurality of markers present on the pedestal.

3. The method of claim 1, further comprising analyzing, by the processor, each of the plurality of images to identify features of the object within each image, wherein the analyzing comprises:
identifying, by the processor, features of the object, wherein the features comprise: lines, shapes, patterns, colors, textures, edge features, corner features, blob features, or a combination thereof; and
translating, by the processor, the identified features of the object into a plurality of feature points.

4. The method of claim 3, further comprising:
determining, for each of the plurality of images, camera position information that indicates a position of the camera relative to the pedestal and the object, wherein the camera position information is determined based at least in part on the plurality of markers of the pedestal; and
associating the plurality of features points identified within a particular image with camera position information determined based on the one or more markers present within the particular image.

5. The method of claim 4, wherein the camera position information for a particular image is determined by identifying, by the processor, one or more markers of the plurality of markers present on the pedestal within the particular image, wherein associating the camera position information to the identified features of the object enables the position of the camera to be determined from subsequent images of the object in which the pedestal is not present.

6. The method of claim 1, wherein the model is configured to interact with an application executing on an electronic device to enable the application to identify and track the object using a camera associated with the electronic device.

7. The method of claim 6, wherein the application is configured to receive a new image of the object captured by the camera associated with the electronic device, and is configured to provide, based on the model, information representative of a position for the camera associated with the electronic device when the new image was captured.

8. A non-transitory computer-readable storage medium storing instructions that, when executed by a processor, cause the processor to perform operations for constructing a model for tracking an object, the operations comprising:
receiving a plurality of images, wherein the plurality of images correspond to images of the object while the object is placed on a pedestal, and wherein a plurality of markers are present on the pedestal;
defining a coordinate system with respect to the pedestal upon which the object is placed based at least in part on the markers present on the pedestal; and
constructing the model for tracking the object based on the plurality of images of the object that were captured while the object is placed on the pedestal and based on the coordinate system, wherein the model for tracking the object is configured to provide information representative of a camera position based on a subsequent image of the object when the pedestal is not present.

9. The non-transitory computer-readable storage medium of claim 8, wherein defining the coordinate system with respect to the pedestal upon which the object is placed further comprises:
assigning, by the processor, a point of origin for the coordinate system; and
orienting, by the processor, the coordinate system based at least in part on the plurality of markers present on the pedestal.

10. The non-transitory computer-readable storage medium of claim 8, wherein the operations further comprise analyzing, by the processor, each of the plurality of images to identify features of the object within each image, wherein the analyzing comprises:
identifying features of the object, wherein the features comprise: lines, shapes, patterns, colors, textures, edge features, corner features, blob features, or a combination thereof; and
translating the identified features of the object into a plurality of feature points.

11. The non-transitory computer-readable storage medium of claim 10, the operations further comprising:
determining, for each of the plurality of images, camera position information that indicates a position of the camera relative to the pedestal and the object, wherein the camera position information is determined based at least in part on the plurality of markers of the pedestal; and
associating the plurality of features points identified within a particular image with camera position information determined based on the one or more markers present within the particular image.

12. The non-transitory computer-readable storage medium of claim 10, wherein the camera position information for a particular image is determined by identifying, by the processor, one or more markers of the plurality of markers present on the pedestal within the particular image, wherein associating the camera position information to the identified features of the object enables the position of the camera to be determined from subsequent images of the object in which the pedestal is not present.

13. The non-transitory computer-readable storage medium of claim 8, wherein the model is configured to interact with an application executed on an electronic device to enable the application to identify and track the object using a camera associated with the electronic device.

14. The non-transitory computer-readable storage medium of claim 13, wherein the application is configured to receive a new image of the object captured by the camera associated with the electronic device, and is configured to provide, based on the model, information representative of a position for the camera associated with the electronic device when the new image was captured.

15. A system for constructing a model for tracking an object, the system comprising:
a pedestal, wherein a plurality of markers are present on the pedestal;
a camera configured to capture a plurality of images of the object while the object is placed on a pedestal;
a processor configured to:
receive the plurality of images captured by the camera;
define a coordinate system with respect to the pedestal upon which the object is placed based at least in part on the markers present on the pedestal; and
construct the model for tracking the object based on the plurality of images of the object that were captured while the object is placed on the pedestal and based on the coordinate system, wherein the model for tracking the object is configured to provide information representative of a camera position based on a subsequent image of the object when the pedestal is not present; and
a memory coupled to the processor.

16. The system of claim 15, wherein the processor is configured to define the coordinate system with respect to the pedestal upon which the object is placed by:
assigning a point of origin for the coordinate system; and
orienting the coordinate system based at least in part on the plurality of markers present on the pedestal.

17. The system of claim 15, wherein the processor is further configured to analyze each of the plurality of images to identify features of the object within each image, wherein, during the analysis of each of the plurality of images, the processor is configured to:
identify features of the object, wherein the features comprise: lines, shapes, patterns, colors, textures, edge features, corner features, blob features, or a combination thereof; and
translate the identified features of the object into a plurality of feature points.

18. The system of claim 17, wherein the processor is configured to:
determine, for each of the plurality of images, camera position information that indicates a position of the camera relative to the pedestal and the object, wherein the camera position information is determined based at least in part on the plurality of markers of the pedestal; and
associate the plurality of features points identified within a particular image with camera position information determined based on the one or more markers present within the particular image.

19. The system of claim 18, wherein the processor is configured to identify one or more markers of the plurality of markers present on the pedestal within the particular image, wherein the camera position information for a particular image based on the one or more markers identified in the particular image, wherein associating the camera position information to the identified features of the object enables the position of the camera to be determined from subsequent images of the object in which the pedestal is not present.

20. The system of claim 15, wherein the model is configured to interact with an application executed on an electronic device to enable the application to identify and track the object using a camera associated with the electronic device.

21. The system of claim 20, wherein the application is configured to receive a new image of the object captured by the camera associated with the electronic device, and to provide, based on the model, information representative of a position for the camera associated with the electronic device when the new image was captured.

22. A non-transitory computer-readable storage medium storing instructions that, when executed by a processor, cause the processor to perform operations for tracking an object based on images captured by a camera communicatively coupled to the processor, the operations comprising:
storing a model of an object, wherein the model is configured to provide camera position information for the camera communicatively coupled to the processor relative to the object based on one or more images received from the camera communicatively coupled to the processor, wherein the model was constructed by associating camera positions with features of the object, the camera positions determined based at least in part on a plurality of markers present on a pedestal, and wherein the object is positioned on the pedestal during construction of the model;
receiving an image of the object from the camera; and
determining a position of the camera relative to the object based on the model.

23. The non-transitory computer-readable storage medium of claim 22, the operations further comprising:
determining a target camera position for the camera relative to the object;
determining one or more directions to move the camera to position the camera in the target camera position based on the model; and
generating an output that indicates the one or more directions to move the camera to position the camera in the target camera position.

24. The non-transitory computer-readable storage medium of claim 23, wherein the model comprises information associated with a coordinate system, and wherein the one or more directions to move the camera are determined, based at least in part, on the coordinate system of the model.

25. The non-transitory computer-readable storage medium of claim 23, the operations further comprising:
receiving a second image of the object from the camera, wherein the second image of the object is captured by the camera subsequent to movement of the camera in a direction corresponding to the one or more directions indicated in the output;
determining, based on the second image, whether the camera is in the target camera position; and
in response to a determination that the camera is not in the target camera position, generating a second output that indicates one or more additional directions to move the camera to position the camera in the target camera position.

26. The non-transitory computer-readable storage medium of claim 25, the operations further comprising performing augmented reality operations based on the second image in response to a determination that the camera is positioned in the target camera position, wherein the target camera position provides a desired orientation of the camera for performing the augmented reality operations.

27. The non-transitory computer-readable storage medium of claim 26, the operations further comprising:
determining a quality metric representative of a strength of a correlation of the features identified in the image of the object to features included in the model; and
determining whether the quality metric satisfies a tracking threshold, wherein the augmented reality operations are performed, based at least in part, on a determination that the quality metric satisfies the tracking threshold.

28. The non-transitory computer-readable storage medium of claim 27, wherein a determination that the quality metric does not satisfy the threshold indicates that the object is not being tracked by the camera.

29. The non-transitory computer-readable storage medium of claim 22, the operations further comprising storing a plurality of additional models, each of the plurality of additional models corresponding to a different object of a plurality of additional objects.

30. The non-transitory computer-readable storage medium of claim 22, the operations further comprising:
identifying features of the object, wherein the features comprise: lines, shapes, patterns, colors, textures, edge features, corner features, blob features, or a combination thereof;
translating the identified features of the object into a plurality of feature points; and
correlating the plurality of feature points identified in the image to feature points derived during construction of the model to determine the camera position.
